(19) United States
(12) Patent Application Publication
(10) Pub. No.: US 2023/0359156 A1
(43) Pub. Date: Nov. 9, 2023

(54) METHOD OF MAKING A REPLACEMENT PART

(71) Applicants: Martin EGGERS, Essen (DE); Malwina UELLENBECK, Dortmund (DE)

(72) Inventors: Martin EGGERS, Essen (DE); Malwina UELLENBECK, Dortmund (DE)

(21) Appl. No.: 18/142,597

(22) Filed: May 3, 2023

(30) Foreign Application Priority Data
May 5, 2022 (EP) 22171862.0

(51) Int. Cl. G05B 13/04; G06Q 30/0283; G06K 7/10

(52) U.S. Cl. CPC G05B 13/048; G05B 13/042; G06Q 30/0283; G06K 7/10297

(57) ABSTRACT

A replacement part for replacing an original mechanical machine part having has an original mechanical configuration with original part descriptive data is made by first receiving performance data obtained by monitoring the machine during operation with the original machine part with one or more sensors and then sending the performance data to a modeling server. The modeling server then calculates multiple optimized mechanical configurations of the replacement part with one or more modeling algorithms based on different optimization criteria using at least the original part descriptive data and the received performance data. Then a selection of several performance options representing the multiple mechanical configurations of the replacement part are provided, one of which is selected by a user. Finally a replacement part is made with the final optimized configuration corresponding to the selected performance option or sending optimized part descriptive or construction data with the final optimized configuration.

### FIELD OF THE INVENTION

The present invention relates to a method of making a replacement part or of making descriptive or construction data for manufacturing a replacement part.

### BACKGROUND OF THE INVENTION

A replacement part for replacing an original mechanical machine part of a machine for conveying a medium typically has an original mechanical configuration with original part descriptive data. The machine generally is part of an industrial plant and/or industrial process or application. The machine is in particular a machine for conveying a medium, for example a pump or a compressor. The medium can be fluid, for example in case of a pump, or gaseous, for example in a compressor. The machine is, for example, a (positive) displacement pump, for example a progressive cavity pump/eccentric screw pump.

The maintenance and servicing of machines is of particular importance in industrial plants and industrial applications which includes the supply of replacement parts/spare parts.

In order to optimize the supply of spare parts, monitoring of the machines and processes is well-known, realizing predictive maintenance solutions. However, the focus of predictive maintenance so far is on the timely delivery of necessary parts, so that generally identical replacement parts are delivered for replacement during usual maintenance intervals, or in case of an actual damage or a predicted damage. Overall, predictive maintenance is of great importance in many fields of industry.

Maintenance optimization for asset performance management is for example described in U.S. Pat. No. 10,466,689 B2. This document suggests a computer implemented method comprising receiving one or more predictive maintenance models each defining a time-based probability of failure for one or more components, receiving current performance data for the components, defining a failure function for each component from the predictive maintenance model for the component and the current performance data for the component, the failure function defining the probability of failure of the component in each of a set of time periods, defining a value loss function for each component from the failure function for the component and a time-based component cost, the value loss function defining the expected value loss due to a planned replacement of the component in a given time period before the component fails or reaches its scheduled end of life, receiving data defining one or more factors that have an impact on the cost of a maintenance option. This method is used for example for a series of machines whereas each machine could be a vehicle in a fleet of vehicles and each component could be discrete components within each vehicle.

Moreover, EP 2 902 930 A2 [U.S. Pat. No. 10,394,970] discusses a system and a method for modeling, simulation, optimization and/or quote creation. A computer may display on a graphical user interface (GUI) a component library including a set of components relating to a compressed air system. The GUI may have a modeling interface for configuring a virtual model using the set of components. The computer may simulate the virtual model to determine one or more optimizations to the compressed air system. The computer may also determine the cost of implementing the compressor system optimization.

It is also well-known that additive manufacturing methods are very interesting for optimizing and making flexible the manufacturing process of machines and machine parts. Therefore, EP 3 751 370 A1 [U.S. Pat. No. 11,567,481] describes an additive manufacturing-coupled digital twin ecosystem based on multi-variant distribution model of performance. A method for making or repairing a specified part is described, the method including creating an optimized process to make or repair the specified part, the creating including: receiving data from a plurality of sources, updating, in real-time, a surrogate model corresponding with a physics-based model of the specified part, wherein the surrogate model forms a digital twin of the specified part, generating a multi-variant distribution including component performance and manufacturing variants, the manufacturing variants being associated with at least one of an additive manufacturing process step and a reductive manufacturing process step. A performance from the multi-variant distribution within expected performance of the new part based on the surrogate model is compared and the optimized process is executed, based on the digital twin, to either repair or make the specified part.

US 2004/0267395 A1 describes control systems and methodologies for controlling a process having one or more motorized pumps and associated motor drives, which provide for optimized process performance according to one or more performance criteria, such as efficiency, component life expectancy, safety, emissions, noise, vibration, operational cost, or the like. More particularly, this document provides for employing machine diagnostic and/or prognostic information in connection with optimizing an overall business operation over time horizon.

Moreover, US 2021/0109513 A1 discusses systems and methods to predict maintenance costs and material consumption, and more particularly the utilization of cumulative cost models to predict asset maintenance costs from distress models.

Finally, a system and method to maintain the health of a control system is known from US 2016/0033941 A1. A recording of running status of process control system software is performed. Then a health assessment of a process control system is carried out using the recorded running status. Using this information, at least one health maintenance recommendation is generated. The recommendations are then implemented to maintain the health of a process control system.

### OBJECTS OF THE INVENTION

It is therefore an object of the present invention to provide an improved method of making a replacement part.

Another object is the provision of such an improved method of making a replacement part or of making descriptive or construction data for a replacement that overcomes the above-given disadvantages, in particular for part of a machine for conveying a fluent medium.

### SUMMARY OF THE INVENTION

To achieve this object, the invention teaches a method of making a replacement part or of making descriptive or construction data for manufacturing a replacement part, the replacement part for replacing an original mechanical machine part of a machine for conveying a medium,
the original part having an original mechanical configuration with original part descriptive data,
the method including the steps of:
   receiving performance data obtained by monitoring the machine during operation with the original machine part with one or more sensors,
   sending the performance data to a modeling server,
   calculating on the modeling server multiple optimized mechanical configurations of the replacement part with one or more modeling algorithms based on different optimization criteria using at least the original part description or construction data and the received performance data,
   providing a selection of several performance options representing the multiple (optimized) mechanical configurations of the replacement part (according to different optimization criteria),
   receiving an input from a user selecting one of the performance options,
   providing the replacement part with the final optimized configuration corresponding to the selected performance option or sending (optimized part) descriptive data or (optimized part) construction data for manufacturing the replacement part with the (final) optimized configuration.

The machine is in particular a machine for conveying a medium, for example a pump or a compressor.

The machine is for example a displacement pump, for example a progressive cavity pump. A progressive cavity pump (or eccentric screw pump) is a pump from the group of displacement pumps used for pumping a wide variety of media and in particular highly viscose liquids in a wide variety of industries. The conveyed liquids can also contain solids. The pump, for example has a pump casing/housing, a stator and a rotor rotating in the stator and a drive mechanism for rotating the rotor, the drive for example connected to the rotor via a connecting shaft and/or a coupling rod whereas the coupling rod compensates for eccentric movement of the rotor or the rotor end.

The invention is based on the idea that predictive maintenance of machines is well-known in the state of the art but is generally focused to timely delivery of replacement parts (spare parts) which are identical to the original mechanical machine parts. In contrast, the method according to the invention does not provide an identical replacement part that is identical to the original machine part, but an optimized replacement part for a machine, and the optimization of the part is realized on the basis of performance data obtained by monitoring the machine during operation with the original machine part with one or more sensors. This means that the machine and/or the process performance of the machine within an industrial plant and operating parameters are monitored, and the monitored data is used for calculating an optimized configuration of the replacement part with a modeling algorithm or several algorithms so that an optimized replaceable machine part can be produced according to specifications based on the optimization process. This basic idea is optimized within the invention in that not only one optimized mechanical configuration of the replacement part is calculated but multiple optimized mechanical configurations of the replacement part are calculated on the modeling server with one or preferably more modeling algorithms based on different optimization criteria. The optimization criteria preferably are a “lifetime or durability optimization” and/or an “operating costs or energy efficiency optimization” and/or a “manufacturing costs optimization”. The inventive method therefore provides a selection, which means a set of several performance options representing the multiple optimized configurations of the replacement part according to these different optimization criteria. A user, for example a customer or client who uses the machine, may select one of these options in order to achieve a replacement part optimized under specific conditions. Based on this input of the user selecting one of these performance options, the replacement part is provided which means that the replacement part with the final optimized configuration corresponding to the selected performance option may be manufactured individually based on (optimized part) descriptive data or (optimized part) construction data calculated on the basis of the selected performance option.

Descriptive data is a set of data appropriate and adapted for manufacturing the replacement part (spare part), for example a drawing or drawing data including all necessary information for manufacturing the part.

Construction data is a specified set of machining data or program code appropriate and adapted for sending it (directly) to a programmable machine, for example a 3D-printer or CNC-machine.

The machine part is a mechanical machine part with mechanical properties which means form, geometry, material and/or material composition. The invention therefore refers to the replacement of a modified mechanical part and not (only) to the modification of software controlling the machine.

The machine part is for example a rotor, a stator, a joint, a bearing or a casing/housing or casing/housing part or casing/housing insert of a machine, for example of a pump or compressor.

The modeling algorithm (or several algorithms) calculate(s) the optimized configurations using at least the original part description or construction data which means the description or construction data of the machine part to be replaced, and using at least the received performance data which means the performance data obtained by monitoring the machine during operation with the sensors. These performance data may include a pressure signal, and/or temperature signal, and/or vibration signal, and/or power consumption signal and/or a flow rate signal. Moreover, the performance data may include process data of an industrial plant into which the machine is integrated. Furthermore, it is possible to (additionally) use other information for optimization, for example financial or economical parameters, such as a TCO (Total Cost of Ownership) optimization or a LCC (Life Cycle Cost) optimization.

The machine generally is part of an industrial plant, and the machine is monitored during operation within the industrial plant at an operating location, for example at an industrial site. The performance data obtained by monitoring the machine is for example sent to a server located outside the operating location, the server receiving the performance data. The server receiving the performance data is for example a cloud server or an edge server. An edge server is a local server generally located at or near the machine, for example at the industrial site. The edge server is typically part of the network at the operation location/industrial plant, so that no data transfer (via internet) is necessary or realized. A cloud-server is a non-local server located far away from the machine, typically located at a data center. According to common practice with regard to cloud servers, the cloud server may also be a virtual server. Cloud servers, and virtual cloud servers in particular, typically come with advantages regarding efficiency and availability. Therefore the invention preferably uses a cloud system and the connection to a cloud or cloud server with data transfer, for example via internet.

The server receiving the performance data may also be or include the modeling server calculating the multiple optimized mechanical configurations of the replacement part. However, in a preferred embodiment the server receiving the performance data on the one hand and the modeling server on the other hand are different (hardware or virtual) servers which may be located at different places and which are in particular located outside the operating location of the machine.

The invention provides a replacement part with the (final) optimized configuration corresponding to the selected performance option. It is generally possible to provide a completed stock item, if for example a couple of machine parts with different mechanical configurations, all compatible with the original machine, are provided or stocked at the supplier. However, in a preferred embodiment, the optimized replacement part is individually manufactured on the basis of the descriptive or construction data, for example using a programmable production device. A programmable production device is for example a device for subtractive or for additive manufacturing. A programmable device for subtractive manufacturing is for example a CNC machine. A machine for additive manufacturing is for example a 3D printer.

It is important that a user, for example a customer of the supplier or manufacturer of the machine or the spare parts, may select the preferred performance option. The selection (I. e. the set of different performance options) for selecting a preferred performance option is preferably provided by a graphical user interface, in particular via an interactive website which may be an online website (for example available on the internet and available via the world wide web) or an offline website (for example hosted locally and available via an intranet).

Furthermore, in particular for the case that the user performing the selection is acting as customer or client of the organization performing the optimization and provision of the replacement part, the inventive method may further include providing a sales quote for the replacement part based on the selected performance option. This means that the client could receive a sales quote before ordering the specific replacement part. The sales quote may be calculated automatically on the basis of the selected performance criteria, and typically contains information such as the price of the selected part, a shipment or delivery date, and delivery terms (for example incoterms).

The selection for selecting the performance option, of making a sales quote and for ordering the replacement part are preferably provided by a graphical user interface, in particular via an interactive website which could be an offline website or an online website. Moreover, a portable device may be used which is linked to the interactive website and displays the website, preferably using a web browser software running on the mobile device.

The described optimized configurations of the replacement part are preferably calculated using a prognostic model of predicted performance. The modeling algorithm used for calculating multiple optimized configurations of the replacement part is therefore based on a prognostic model of predicted performance. Examples for modeling algorithms may include finite element method (FEM) physical simulation of the behavior of the machine and medium (for example fluid) for various mechanical configurations of the replacement part, in combination with one or more evaluation functions, which rate(s) the performance of the currently evaluated mechanical configuration based on the optimization criteria and an iterative method or heuristic which generates potential candidates for evaluation. Examples for iterative methods include gradient descent methods or pattern search methods, examples for heuristics include evolutionary algorithms, genetic algorithms, and hill climbing.

As described, original part descriptive data and performance data are used for calculation and therefore have to be provided for example from a user/client using the machine within an industrial plant. The original description or construction data (and the performance data) maybe provided from the client/customer/user to the supplier as a digital object containing the descriptive data, the digital object forming a digital twin of the original part.

Moreover, as described, the descriptive or construction data for manufacturing the replacement part with the optimized configuration according to the selected performance option is provided, and for example a supplier provides the data to a customer using the machine. This descriptive or construction data can be provided from the supplier to the client/customer as a digital object forming a digital twin of the optimized part.

A digital object is a machine independent data structure comprising or consisting of an identity, attributes and data in digital form that can be parsed by different information systems and thus enables interoperability between diverse information formats on the internet.

A digital twin is a digital or virtual counterpart of a physical object or process. In particular, a digital twin is a virtual representation (or counterpart) of a (physical) product or workflow/process during its entire life cycle. Generally a digital twin or the digital twin concept is composed of three elements: a physical item in real space, the digital twin in software form and the data that links these two elements.

In particular, it is an advantage to provide the digital object, in particular a digital object containing the part construction data, as a DRM protected digital object which means a digital object protected with a specified Digital Rights Management. This is an advantage in order to prevent unauthorized use of the part construction data, such as multiple productions of the part, and in particular in order to prevent misuse of the data without definite permission by the owner of rights. A DRM method may, for example, include cryptographic signing and encryption of the part construction data, and include a step where the authenticity of the digital object containing the part construction data is verified by the programmable production device prior to the production of the part, and the part construction data is decrypted based on a cryptographic key provided by a server, the server preferably being provided by the supplier, upon successful verification of the digital object. The DRM method may furthermore include a copy limit, which ensures that the part construction data may not be decrypted an arbitrary number of times, for example by limiting the number of times the cryptographic key is provided by the server.

The invention not only covers the analyzing process and calculation process and the production process of the replacement part but may also cover the corresponding business transactions and business communication, for example, the process step of offering the replacement part with the optimized configuration and the process step of payment.

The inventive method may further provide an ID tag (identification tag) at a location on the machine for conveying a medium, and the ID tag is read by the portable device and upon reading the ID tag, the selection is provided on the portable device. The ID tag may be an optical code, for example a QR code or alternatively a radio tag, for example an NFC tag or RFID tag. The ID tag may encode a uniform resource identifier (URI), in particular a uniform resource locator (URL). For example, the ID tag may encode a URL which points to a website which contains the digital twin for the machine, which also provides the selection as one of the options to interact with the digital twin via the website.

Moreover, the invention not only covers the described method but also a system for making a replacement part or of making descriptive or construction data for manufacturing a replacement part, and the system uses a method as described or the system preferably is adapted for performing the method described. The system includes at least a modeling server, and one or more modeling algorithms are stored on the modeling server, the modeling algorithms calculating multiple optimized mechanical configurations of the replacement part based on different optimization criteria using at least the original part descriptive or construction data and the received performance data. The system is arranged of making a selection of several performance options representing the multiple optimized mechanical configurations of the replacement part according to different optimization criteria, and this selection may be provided by a graphical user interface, for example with a portable device (smartphone, tablet, notebook, smartwatch). Moreover, the system may include the machine with the original mechanical machine part to be replaced and the system may include one or more sensors for monitoring the machine during operation.

### BRIEF DESCRIPTION OF THE DRAWING

The above and other objects, features, and advantages will become more readily apparent from the following description, reference being made to the accompanying drawing in which:

FIG. 1 is a schematic diagram of a system and a method according to the invention,

FIG. 2 shows a detail of a modified embodiment according to FIG. 1 and

FIG. 3 shows another embodiment of the invention.

### SPECIFIC DESCRIPTION OF THE INVENTION

The drawing shows different embodiments of a system and a method of making a replacement part 1 of a machine 3 or of making descriptive or construction data 15 for manufacturing the replacement part 1.

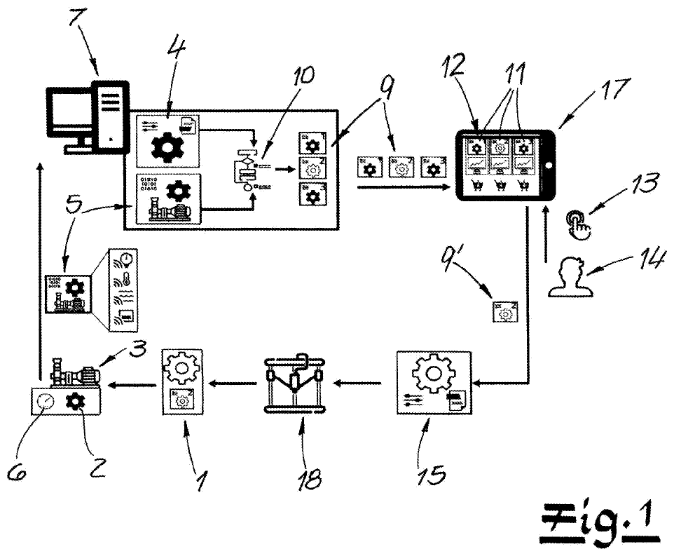

FIG. 1 schematically shows the machine 3 for conveying a medium which could be a pump for example, including several mechanical machine parts and in particular at least one mechanical machine part 2 to be replaced by a replacement part 1. The original machine part 2 to be replaced is a mechanical part with mechanical properties which means form, geometry, material and/or material composition. The original mechanical configuration of this machine part 2 is represented by so called original part descriptive data 4 which is a set of data appropriate and adapted for manufacturing the part, for example a drawing or drawing data including all necessary information for manufacturing the part.

In order to provide a modified and in particular optimized replacement part 1 the invention is based on the idea of monitoring the machine 3 during operation with the original machine part 2 with one or more sensors 6 schematically shown in FIG. 1. The sensors 6 provide performance data 5 obtained by monitoring the machine 3 during operation, and the performance data 5 may include a pressure signal, a temperature signal, a vibration signal, a power consumption signal or a flow rate signal achieved during operation of the machine 3. This performance data 5 is sent to a modeling server 7 which is configured for calculating an optimized configuration of the replacement part 1 with a modeling algorithm 10. The method according to the invention therefore does not provide an identical replacement part that is identical to the original machine part but an optimized replacement part 1 for a machine 3. The optimization of the part is realized on the basis of performance data 5 obtained by monitoring the machine 3 during operation with the original machine part 2. However, this basic idea is developed further within the invention in that not only one optimized mechanical configuration of the replacement part 1 is calculated but multiple optimized mechanical configurations 9 are calculated on the modeling server 7 with one more modeling algorithms 10 based on different optimization criteria. These different optimization criteria are for example a lifetime or durability optimization and an operating costs or energy efficiency optimization and a manufacturing costs optimization. The system, for example the modeling server 7, provides a selection 11 of several performance options which means a set of several performance options, representing the multiple optimized mechanical configurations 9 of the replacement part 1 according to the described optimization criteria.

As shown in FIG. 1, the selection/set 11 of the multiple optimized configurations 9 is for example provided by a graphical user interface 12, for example by a portable device 17 presenting/displaying the selection/set 11 of the different performance options or different optimized configurations 9. A user 14, for example a customer who uses the machine, may now select one of these options in order to achieve a replacement part 1 optimized under these specific conditions. This input/selection 13 of the specific performance option is sent to a server, which may be the modeling server or another server providing the selected final optimized configurations, and the server provides the final optimized descriptive data or final optimized construction data 15 for manufacturing the replacement part 1 with the final optimized configuration 9′. This data is for example sent to a programmable production device 18 which is for example a device for additive manufacturing or alternatively for subtractive manufacturing. The device 18 produces the specific replacement part 1 which is not identical to the original replacement part 2 but which is specifically optimized on the basis of the monitoring data 5 and in particular optimized on the basis of a specific optimization criteria selected by the user/client 14.

The new and modified replacement part 1 is sent to the customer installing this replacement part 1 to the machine 3 in order to replace the original part 2. As an alternative, the optimized part descriptive or construction data 15 can be sent to the customer directly who is able to produce the replacement part on his own or an external facility using a programmable production device.

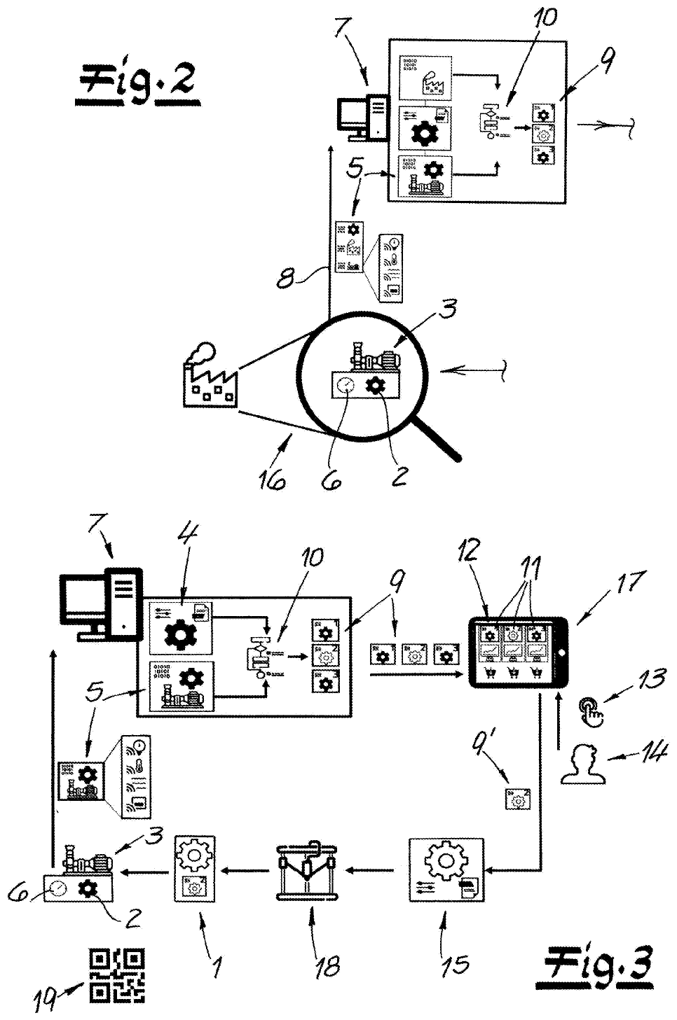

As described with regard to FIG. 1 the modeling server 7 calculates the optimized mechanical configuration of the replacement part on the basis of the performance data 5 obtained by monitoring the machine with the monitoring devices 6. FIG. 2 shows a modified embodiment of the invention whereas the machine 3 is part of an industrial plant 16 creating and providing additionally process data 8 of the industrial plant 16. According to FIG. 2 this process data 8 is also sent to the modeling server 7 so that a modeling server 7 not only receives the performance data 5 of the machine 3 but also the process data 8 of the industrial plant 16 including the machine 3. The modeling server 7 calculates the multiple optimized mechanical configurations 9 of the replacement part 1 not only on the basis of the performance data 5 but also on the basis of the process data 8 received from the industrial plant 16.

FIG. 3 shows a modified embodiment of the invention using a machine 3 which is equipped with an ID tag 19 located on the machine, for example on the casing of the machine whereas this ID tag can be read by a portable device 17, for example a smart phone. Upon reading the ID tag 19, the portable device directly provides the selection 11 described above which means that the portable device 17 provides the possibility to select a specified optimization criterion. The ID tag 19 preferably is an optical code, for example a QR code. As an alternative, the ID tag can be a radio tag, for example an NFC tag or a RFID tag. Preferably the ID tag 19 encodes a uniform resource identifier (URI), in particular an uniform resource locator (URL).

All figures show embodiments with a modeling server 7 which receives the data, calculates the different configurations and sends these configurations to the portable device 17. This modeling server 7 can be an edge server which is for example located at the industrial plant or at the industrial site near the machine. As an alternative the modeling server 7 can be a cloud server which is a nonlocal server located far away from the machine. Moreover, it is possible to use several servers whereas one or more servers can be edge servers and one or more servers can be cloud servers, in particular, servers located at a data center and/or virtual servers running in a cloud computing environment.

As shown in the figures, the modeling server 7 uses not only the performance data 5 receiving from the machine but also the original part descriptive data 4 or original part construction data characterizing the detailed construction of the original part which is to be replaced by an optimized part. The figures show the possibility that this original part construction or descriptive data 4 is stored in the modeling server 7 which means that the modeling server 7 has all necessary information about the original part. Alternatively, it is also possible that the modeling server 7 receives the necessary information about the original part 2 from another source, for example from another server or directly from the machine. In any case it is an advantage, if the original part description 4 or construction data 15 is provided as a digital object forming a digital twin of the original part 2. Moreover, it is an advantage if the descriptive data 4 or construction data 15 of the replacement part 1 is provided as a digital object, forming a digital twin of the final replacement part 1. Preferably these digital objects are provided as DRM (Digital Rights Management) protected digital objects. These details are not shown in the figures.

As already described, the invention not only covers the system and the analyzing process and calculation process and the production process of the replacement part 1 but also the corresponding business transactions and business communication, for example the process step of offering the replacement part 1 with optimized configuration and the process step of payment. These optional process steps are not shown in the figures.

We claim:

1. A method of making a replacement part or of making descriptive or construction data for manufacturing a replacement part replacing an original mechanical machine part of a machine for conveying a medium where the original part has an original mechanical configuration with original part descriptive data, the method comprising the steps of:
receiving performance data obtained by monitoring the machine during operation with the original machine part with one or more sensors;
sending the performance data to a modeling server;
calculating on the modeling server multiple optimized mechanical configurations of the replacement part with one or more modeling algorithms based on different optimization criteria using at least the original part descriptive data or construction data and the received performance data;
providing a selection of several performance options representing the multiple mechanical configurations of the replacement part;
receiving an input from a user selecting one of the performance options; and
providing the replacement part with the final optimized configuration corresponding to the selected performance option or sending optimized part descriptive or construction data for manufacturing the replacement part with the final optimized configuration.

2. The method according to claim 1, wherein the optimization criteria include at least one of a lifetime or durability optimization, an operating costs or energy efficiency optimization, and/or a manufacturing costs optimization.

3. The method according to claim 1, wherein the machine for conveying a medium is a pump or a compressor.

4. The method according to claim 1, wherein the machine part is a mechanical machine part with mechanical properties with respect to form, material and/or material composition.

5. The method according to claim 1, wherein the machine part is a rotor, a stator, a joint, a bearing or a casing or casing part or insert.

6. The method according to claim 1, wherein the performance data includes a pressure signal, a temperature signal, a vibration signal, a power consumption signal or a flow rate signal.

7. The method according to claim 1, wherein the machine is part of an industrial plant and in addition to the performance data also process data of the industrial plant is sent to the modeling server and is used for calculating the multiple optimized mechanical configurations.

8. The method according to claim 1, wherein the selection for selecting the performance option is provided by a graphical user interface via an interactive online or offline website.

9. The method according to claim 1, further including the step of:
monitoring the machine during operation at an operating location with one or more sensors and providing or sending the performance data to the modeling server.

10. The method according to claim 1, wherein the modeling server is a cloud server located outside the operation location, and the data preferably is transferred via internet.

11. The method according to claim 1, wherein the modeling server is an edge server located at the operation location.

12. The method according to claim 1, the method further including the step of:
manufacturing the replacement part based on the construction data provided for the selected performance option.

13. The method according to claim 12, wherein the replacement part is manufactured using a programmable production device doing subtractive or additive manufacturing.

14. The method according to claim 1, wherein the modeling algorithm calculating multiple optimized configurations of the replacement part uses a prognostic model of predicted performance.

15. The method according to claim 1, wherein the original part descriptive data is provided as a digital object forming a digital twin of the original part.

16. The method according to claim 1, further including the step of:
providing a digital object containing a specification of the replacement part and/or the descriptive or construction data of the replacement part, the digital object forming a digital twin of the final replacement part.

17. The method according to claim 15 whereas the digital object is provided as a DRM protected digital object.

18. The method according to claim 1, the method further including the step of:
providing a sales quote for the replacement part based on the selected performance option.

19. The method according to claim 1, wherein the selection for selecting the performance option, of making a sales quote and for ordering the replacement part are provided by a graphical user interface by an interactive website.

20. The method according to claim 19 using a portable device linked to the interactive website and/or displaying the interactive website.

21. The method according to claim 1, further comprising the steps of:
providing an ID tag at a location on the machine for conveying a medium;
reading the tag with a portable device and thereby reading the ID tag;
displaying a selection of several performance options on the portable device.

22. The method according to claim 21, wherein the ID tag is a QR code, a radio tag, an NFC tag, or an RFID tag.

23. The method according to claim 21, wherein the ID tag encodes a uniform resource identifier.

24. A system for making a replacement part or of making descriptive or construction data for manufacturing a replacement part, using a method as defined in claim 1,
the system including
a modeling server set up for receiving performance data obtained by monitoring the machine during operation with the original machine part and for calculating multiple optimized mechanical configurations of the replacement part with one or more modeling algorithms based on different optimization criteria using at least the original part descriptive data or construction data and the received performance data and of making a selection of several performance options representing the multiple optimized mechanical configurations of the replacement part according to different optimization criteria.

25. The system according to claim 24, the system further including
a machine for conveying a medium containing the mechanical machine part to be replaced and with one or more sensors of making performance data of the machine during operation.

26. The system according to claim 24, further including
a portable device which is linkable to an interactive website and/or displaying an interactive website, the interactive website providing the selection for selecting the performance options.
